(19) United States
(12) Patent Application Publication
(10) Pub. No.: US 2021/0378269 A1
(43) Pub. Date: Dec. 9, 2021

(54) HIGH PRESSURE ISOSTATIC PRESSING ASSEMBLY, IN PARTICULAR FOOD HIGH PRESSURE PROCESSING ASSEMBLY

(71) Applicant: EXDIN SOLUTIONS SPOLKA Z OGRANICZONA ODPOWIEDZIALNOSCIA, Krakow (PL)

(72) Inventors: Grzegorz Widlak, Krakow (PL); Lukasz Wachowicz, Krakow (PL); Rafal Brzegowy, Lipnica Mala (PL); Grzegorz Koryl, Rzeszow (PL)

(21) Appl. No.: 17/283,394

(22) PCT Filed: Oct. 10, 2018
(86) PCT No.: PCT/PL2018/000096

§ 371 Date: Apr. 7, 2021

(51) Int. Cl. A23L 3/015; B30B 7/02; B30B 15/02

(52) U.S. Cl. CPC A23L 3/0155; A23V 2002/00; B30B 15/028; B30B 7/023

(57) ABSTRACT

A high pressure isostatic pressing food processing assembly (1a) has a vessel (2) with an internal chamber (21) closed at both ends with two head assemblies (3), each having a body (31) that includes a blocking chamber (32), a plug (35) disposed displaceably within the blocking chamber (32) and provided with a sealing means (351) apt to enter and sealingly close the internal chamber (21) during a pressure applying phase. The assembly (1a) includes at least two longitudinal tie-rods (4) juxtaposed around an external surface of the vessel (2), wherein each end of each tie rod (4) passes through a tie member (6), coupled with the vessel (2), and is coupled with a resisting surface (421, 43) transferring axial load on the tie member (6) at an axially external side of the end of the tie rod (4).

### BACKGROUND OF THE INVENTION

The invention relates to a high pressure isostatic pressing assembly, in particular food high pressure processing assembly, comprising at least one high pressure, longitudinal vessel having an internal chamber closed at both axial ends with two head assemblies, each comprising a body adjoining the vessel, wherein at least one of the head assemblies further comprises a blocking chamber located within the body transversely relative to the longitudinal axis of the vessel, a loading outlet, substantially aligned with the axis of the vessel, joining an axially external side of the body with said blocking chamber, and having cross-sectional area substantially corresponding to the cross-sectional area of the vessel, and a plug disposed displaceably within the blocking chamber and provided with a sealing means apt, i.e., fitted to enter and sealingly close the internal chamber of the vessel during the pressure applying phase of the vessel.

High pressure cylindrical vessels are successfully utilized in different high pressure applications. In particular they are used in food High Pressure Processing (HPP) systems, in which food products are subjected to very high pressures, in the range of 200 to 1 000 MPa.

Patent publication U.S. Pat. No. 5,585,076 discloses an installation for subjecting substances packaged in flexible packets to high pressure treatment including a cylindrical vessel provided with a head assembly at each end. Each head assembly includes a moving assembly that can be displaced perpendicularly to the axis of the enclosure. The moving assembly includes a stopper type plug provided with a seal, a spacer provided with a pull rod a drawer and a plugging body. The moving assembly is slidably mounted in a force take-up member. Via co-operation between sloping ramps carried by the plug and complementary sloping grooves in the drawer, the transverse displacement of the drawer causes axial displacements of the plug. The spacer in the form of a fork with two prongs flanking the stem of the plug is mounted to slide in the drawer and is situated between the plug and the plugging body.

Axial forces induced by the pressure inside the vessel are in this installation transferred by the head assemblies in a tensile manner to the vessel which reduces durability of the vessel, while cyclic loads are applied. Both local stress concentrations and global stress pattern are thus unfavorable in this installation.

It has been an object of the present invention to provide a high pressure isostatic pressing assembly, in particular food high pressure processing assembly which would minimize the amplitude of cyclic stresses applied to the load carrying members of the assembly that transfer axial loads and thus increase its fatigue life. Yet another object of the present invention has been to provide a durable, simple and cost-efficient high pressure assembly enabling fast and simple loading and unloading operations.

### SUMMARY OF THE INVENTION

The term “loading phase” as used in the context of this specification refers both to loading the vessel with products to be processed, as well as unloading it with products after high pressure processing; the term “pressure applying phase” refers to applying a pressure inside the vessel sealingly closed by the plugs using a liquid (usually water); while the term “closing phase” refers both to closing the vessel with plugs entering its internal chamber before pressure applying phase, as well as opening it after this phase.

Terms “axial”, “radial”, “annular” refer to a polar coordinate system describing the locations of the assembly components with respect to the longitudinal axis of the vessel.

The invention provides a high pressure isostatic pressing assembly, as recited in the preamble, which is characterized in that it further comprises at least two longitudinal tie-rods juxtaposed, preferably symmetrically, around the external surface of the vessel at the radially external side of the blocking chamber, wherein each end of each tie rod passes through a tie member, coupled with the vessel, and is coupled with a resisting surface transferring axial load on said tie member at the axially external side of said end of said tie rod, wherein said resisting surfaces axially preload said tie-rod, said body and said vessel, and the preload force is adjusted at least to the value ensuring that no separation between said body and said vessel occurs during the pressure applying phase of the vessel.

The rods create a prestressed system of the assembly, so that the vessel is axially compressed in all the range of pressures (i.e. both during the loading and closing phase, as well as during the pressure applying phase) by the head assemblies coupled with the tie-rods. The tie-rods preload level ensures integrity of the assembly construction, so there is no need of mechanical joints (e.g. threads, pins, grooves) that commonly generate stress concentrations. Preloads falling below this level on the other hand might lead to a decoupling of the head assemblies from the vessel which is disadvantageous, as it may cause sudden increase of tensile load in the tie-rods with large amplitude of stress causing accelerated fatigue.

Preferably the bodies of the two head assemblies of the high pressure isostatic pressing assembly are coupled with each other by said at least two longitudinal tie-rods. In this embodiment the vessel I preloaded over its entire length.

in such a case preferably the combined preload force (Tₚ) of all said tie-rods is adjusted at least to the value of the axial force (Fᵥ) generated in the vessel during the pressure applying phase multiplied by the axial stiffness (Cᵥ) of the vessel relative to the axial stiffness of said tie-rods and the axial stiffness (Cᵥ) of the vessel according to the formula

Tₚ≥Fᵥ·Cᵥ/(Cᵥ+Cₜ).

Preferably said tie member of said longitudinal tie-rod is the body of the head assembly, adjoins or is coupled with the body of the head assembly or the body of the head assembly has a multipart construction and said tie member is the most axially external part of said body transferring axial loads on the vessel.

Preferably the blocking chamber of said at least one head assembly is provided with an axially external face and the plug is provided with an axially external face, wherein said at least one of the head assemblies further comprises a blocking gate having axial width lower than the axial width of the blocking chamber, which is disposed slidably within said blocking chamber and is provided with an axially external face abutting said axially external face of the blocking chamber and an axially internal face, wherein said axially external face of the plug abuts said axially internal face of said blocking gate during the pressure applying phase and is axially displaced from said axially internal face of said blocking gate toward said loading outlet during the loading phase.

Therefore the plug is entirely supported in axial direction by the blocking gate during the pressure applying phase, which enables the transfer of the forces generated by the pressure inside the vessel in to the head assembly and the tie-rods. The plug is also to a large extent displaceable in the blocking chamber and these displacements may be simply defined by system of axial and transverse linear guides and enforced e.g. by at least one, or preferably two hydraulic, pneumatic or mechanical actuator(s). It may be therefore precisely introduced axially into the internal chamber of the vessel, as well as easily moved aside, providing access to the vessel. Finally the blocking assembly including just the plug and the blocking gate disposed, as described, in the blocking chamber is simple and easy in construction and servicing.

In this embodiment preferably said blocking gate is provided with a loading channel having cross-sectional area substantially corresponding to the cross-sectional area of the internal chamber of the vessel, that passes between said axially external face and said axially internal face of said blocking gate substantially in parallel with the axis of the vessel, and during loading phase is substantially aligned with said loading outlet.

Also in these embodiments preferably said plug is supported on said blocking gate.

Preferably at least one of the head assemblies further comprises a plug socket joining the blocking chamber with the internal chamber of the vessel and said plug is disposed displaceably also within said plug socket.

Preferably displacements of the plug within the blocking chamber are determined with respect to the body of the head assembly.

Preferably said plug is provided with a pressure applying channel.

Preferably said resisting surfaces are pressed by at least one nut, which may be preferably screwed on an external thread of said tie rod.

Alternatively or additionally said resisting surfaces are preferably pressed by a multi-bolt tensioning system.

Preferably the high pressure assembly according to the present invention comprises a number of vessels disposed in parallel with each other and closed at their axial ends with two common head assemblies.

### BRIEF DESCRIPTION OF DRAWINGS

The invention shall be described and explained below in exemplary embodiments and in connection with the attached drawings on which:

FIG. 1 is a schematic perspective view of an embodiment of a high pressure assembly for food high pressure processing according to the present invention;

FIG. 2 is a schematic perspective cross-sectional view of the assembly shown in FIG. 1;

FIG. 3 is a schematic perspective view of another embodiment of a high pressure assembly according to the present invention;

FIGS. 4a, 4b, and 4c are schematic cross-sectional views of the closing head assembly of the high pressure assembly during loading phase (FIG. 4a), closing phase (FIG. 4b), and pressure applying phase (FIG. 4c).

### DETAILED DESCRIPTION OF PREFERRED EMBODIMENT

In the following description numerical references of elements performing the same functions remain the same in the drawings, wherein suffixes (a, b, . . . ) were added, where appropriate, to additionally distinct elements having different construction.

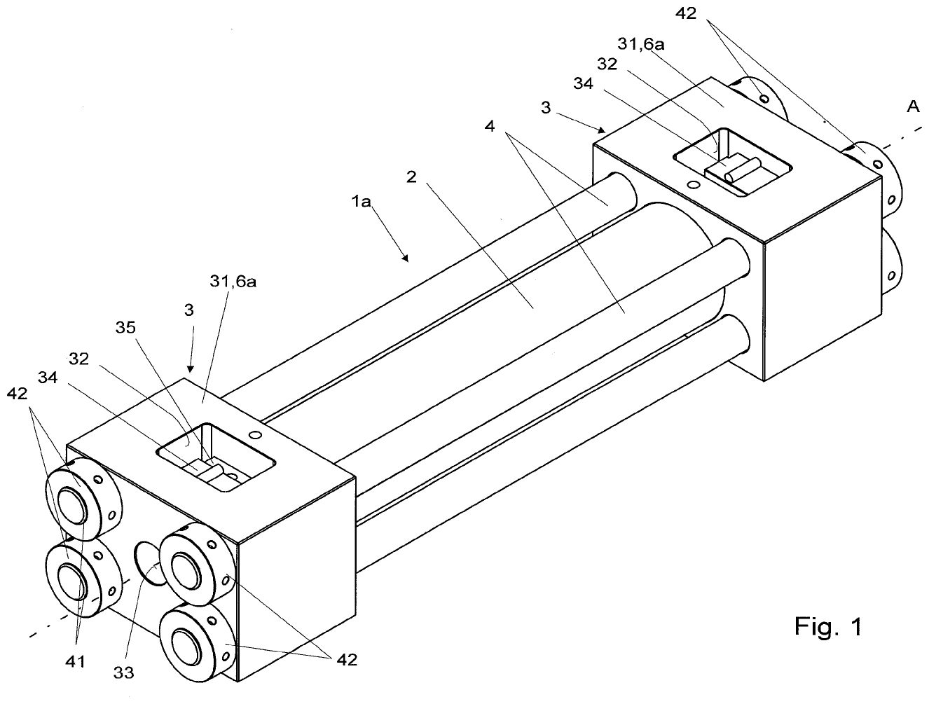

An exemplary embodiment of a high pressure isostatic pressing assembly 1a for food High Pressure Processing is shown in in FIG. 1. The assembly 1a comprises a high pressure, longitudinal, cylindrical vessel 2 provided with an internal chamber 21 of a construction known to those skilled in the art (such as, but not limited to monoblock, wire wound, multilayer, the one disclosed by the inventor of the present application in the international PCT publication WO 2015/133915 A1, etc.) that shall not be described in detail. In the presented embodiment the vessel 2 is shown to be disposed substantially horizontally. In other embodiments however the vessel 2 may be sloped with respect to the horizontal plane or even vertical. Particular positions of the elements of the isostatic pressing assembly are referred with respect to the polar coordinate system defined by the axis A of the vessel 2.

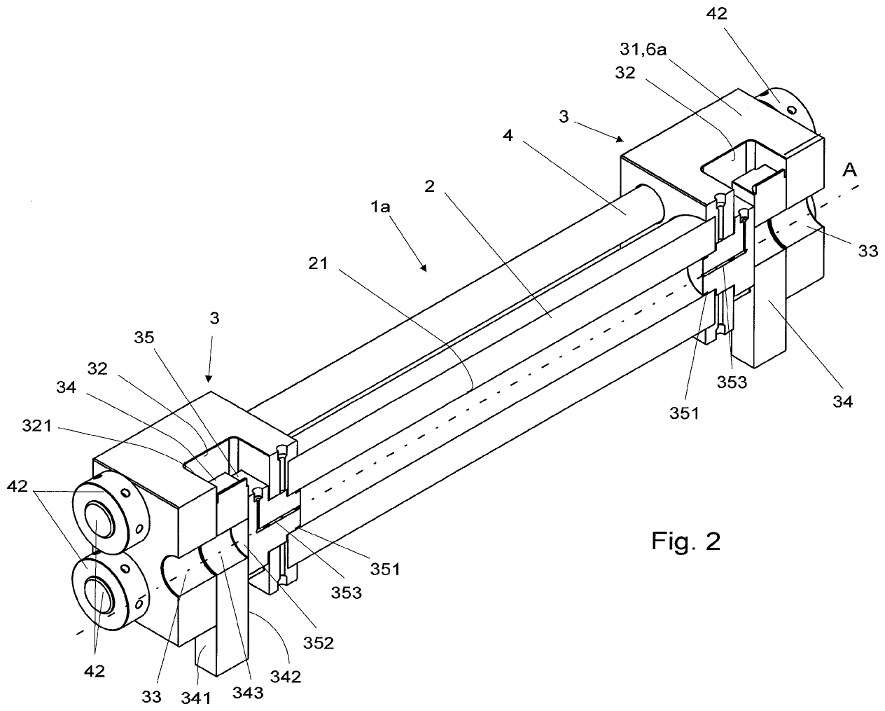

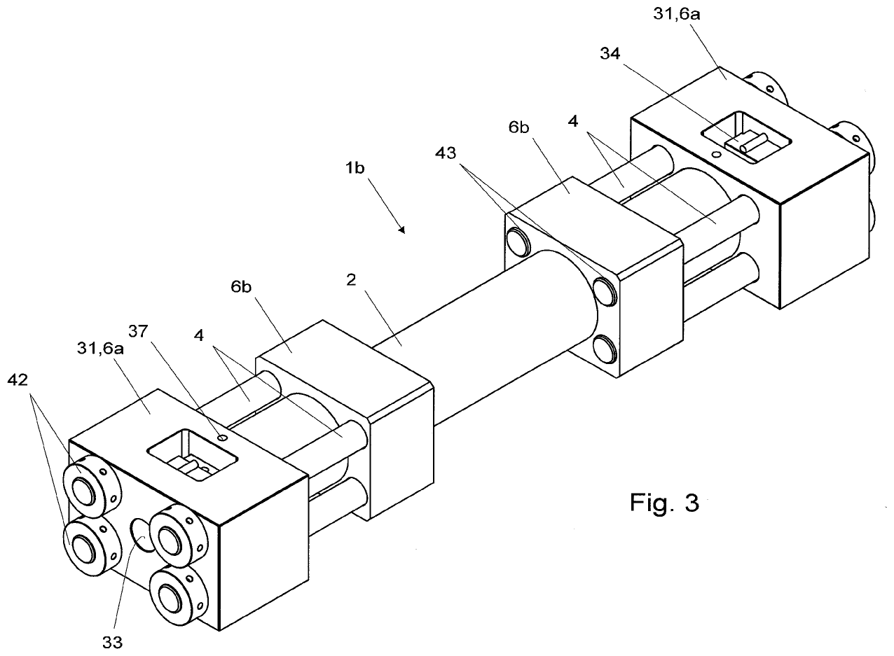

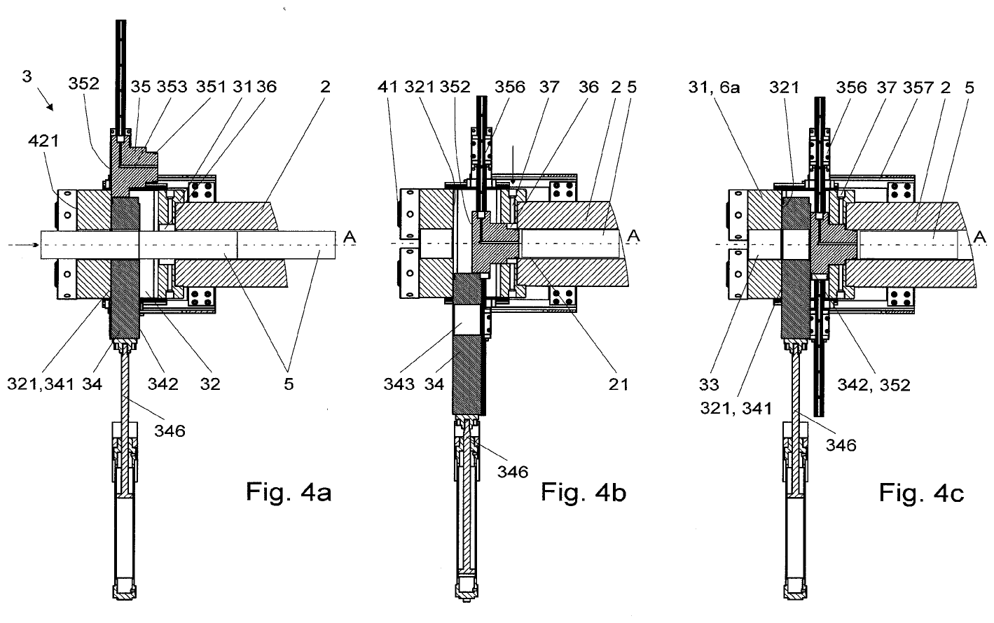

The vessel 2 is closed from both ends by two head assemblies 3. The head assemblies 3 and thus also the vessel 2 are coupled with each other by four longitudinal tie-rods 4 juxtaposed around the external surface of the vessel 2. Each end of each rod 4 passes through a longitudinal opening in a tie member 6a coupled with the vessel 2. In this embodiment the tie member 6a is a solid body 31 of the head assembly 3. In other embodiments it could be an additional flange or plate adjoining the head assembly 3 or otherwise coupled with the vessel 2 (cf. FIG. 3). At the axially external side each end of each tie rod 4 is coupled with a resisting surface 421 (cf. FIG. 4a) transferring axial load between the tie member 31 and the tie-rod 4 at the axially external side of the end of the tie rod 4. The resisting surfaces 421 axially preload the tie-rods 4, the bodies 31 and the vessel 2, and the preload force is adjusted at least to the value ensuring that no separation between the body 31 and the vessel 2 occurs during the pressure applying phase of the vessel 2 (cf. FIG. 2 and FIG. 4c).

In this embodiment the resisting surfaces 421 are defined by the axially internal surfaces of nuts 42 abutting the bodies 31 at their axially external sides. In other embodiments the resisting surfaces may be defined by washers between the nuts 42 and the tie members 6, heads of the tie-rods 4 (cf. FIG. 3), ends of bolts of a multi-bolt tensioning system, or even directly by thread surfaces of the tie-rods 4 screwed inside the tie members 6a or 6b. In this embodiment the axial preload is produced directly by the nuts 42 screwed on the external threads 41 of the tie rods 4. It should be appreciated however that this axial preload may be produced by various techniques and means known to those skilled in the art such as, but not limited to, hydraulic tensioners (e.g. SKF® Hydrocam Bolt Tensioners, Atlas Copco® Tentec CTST tensioners) or mechanical tensioners, including multi-bolt, tensioners (e.g. Superbolt™ Multi-Jackbolt Tensioners, etc.).

In this embodiment the total preload force Tₚ of all the tie-rods 4 is adjusted at least to the value of the axial force Fᵥ generated in the vessel 2 during the pressure applying phase multiplied by the stiffness Cᵥ of the vessel 2 relative to the stiffness Cₜ of the tie-rods 4 and the stiffness of the vessel 2 according to the formula

Tₚ≥Fᵥ·Cᵥ/(Cᵥ+Cₜ).

Such a value of the preload force Tₚ reduces the effect of cycling loading on the tie-rods 4 produced by the pressure inside the vessel during pressure applying phase and extends the service life of the load carrying members of the assembly.

Each head assembly 3 is further provided with a plugging assembly enabling packaged products 5 containing the substances that are to be subjected to high pressure treatment to be loaded and unloaded in and out of the vessel 2 (cf. FIG. 4a), and to perform the high pressure treatment by the water that has been fed into the vessel 2 (cf. FIG. 4c).

To this end, as shown in FIG. 2, each head assembly 3 comprises a blocking chamber 32, passing transversely through the body 31 between two pairs of adjacent tie-rods 4, substantially perpendicularly to the axis A of the vessel 2, which is provided with an axially external face 321. A loading outlet 33, substantially aligned with the axis A of the vessel 2, passes longitudinally through the body 31 and has a cross-sectional area substantially corresponding to the cross-sectional area of the internal chamber 21 of the vessel 2. A plug 35 of a stopper type is disposed displaceably within the blocking chamber 32 and is provided with a sealing means 351 apt, i.e., fitted to or suited to enter and sealingly close the internal chamber 21 of the vessel 2 during the pressure applying phase.

In this embodiment the head assembly 3 further comprises a plug socket 36 (cf. FIG. 4a, FIG. 4b) joining the blocking chamber 32 with the internal chamber 21 of the vessel 2. The plug 35 is disposed displaceably also within the plug socket 36, while displacements of the plug 35 within the blocking chamber 32 are in this embodiment determined with respect to the body 31 of the head assembly 3.

In this embodiment the head assembly 3 further comprises a blocking gate 34 having axial width lower than the axial width of the blocking chamber 32 which is disposed slidably and substantially perpendicularly to the axis A of the vessel 2, within the blocking chamber 32. The blocking gate 34 is provided with an axially external face 341 abutting the axially external face 321 of the blocking chamber 32, as well as an axially internal face 342. As shown an axially external face 352 of the plug 35 abuts this axially internal face 342 of the blocking gate 34 during the pressure applying phase. During the loading phase (cf. FIG. 4a, 4b) the axially external face 352 of the plug 35 is axially displaced with respect to the axis A from the axially internal face 342 of the blocking gate 34 toward the loading outlet 33, and the plug 35 is supported on the blocking gate 34.

In this embodiment the blocking gate 34 is also provided with a loading channel 343, having cross-sectional area substantially corresponding to the cross-sectional area of the internal chamber 21 of the vessel 2, that passes between the axially external face 341 and the axially internal face 342 of the blocking gate 34 substantially in parallel with the axis A of the vessel 2. During the loading phase the loading channel 343 is substantially aligned with said loading outlet 33 of the head assembly 3.

FIG. 3 illustrates another embodiment of a high pressure isostatic pressing assembly 1b closed from both ends by two head assemblies 3 and comprising axially internal tie members 6b fixed to the vessel 2 by means of thread, groove or clamp connection or interference fit assembly. Each head assembly 3 of the assembly 1b is coupled with the tie member 6b by four longitudinal tie-rods 4 juxtaposed around the external surface of the vessel 2. Axially external ends of each tie-rod 4 pass through longitudinal openings in the bodies 31 of the head assemblies 3. Axially internal ends of each tie-rod 4 are terminated with heads defining axially internal resisting surfaces 43 transferring axial load on the tie members 6b. Similarly as in the embodiment shown in FIG. 1 axially external resisting surfaces 421 are defined by the axially internal surfaces of the nuts 42 abutting the bodies 31 of the head assemblies 3, which axially preload the tie-rods 4, the bodies 31 and the vessel 2, and the preload force is adjusted at least to the value ensuring that no separation between the bodies 31 and the vessel 2 occurs during the pressure applying phase of the vessel 2.

FIG. 4a illustrates the operation of the high pressure assembly during the loading phase. As shown an actuator 346 maintains the position of the blocking gate 34 having its loading channel 343 aligned with the loading outlet 33 of the head assembly 3 and the internal chamber 21 of the vessel 2 (In another embodiment the blocking gate 34 might be displaced by an actuator 346 entirely aside the blocking chamber 32, while another actuator would displace the plug 35 in the opposite direction). In this position food products 5 are inserted into the internal chamber 21 of the vessel 2, as indicated by an arrow. The actuator 346 maintains also the radially external position of the plug 35 which rests upon the radially internal face of the gate 34. Obviously FIG. 4a illustrates also the unloading phase, during which the processed products 5 are being withdrawn from the internal chamber 21.

FIG. 4b illustrates the closing phase. As shown the actuator 346 lowered the blocking gate 34 along with the plug 35 resting upon it to the position where the plug 35 is axially aligned with the plug socket 36 passing through the body 31 and joining the blocking chamber 32 with the internal chamber 21 of the vessel 2. As shown the plug 35 has been axially displaced toward the internal chamber 21, along with a rail 356 and a supporting frame 357 by means of a actuator (not shown) acting in parallel to the axis A. In this position the axially external face 352 of the plug 35 is axially displaced from the internal face 342 of the blocking gate 34 toward the loading outlet 33. In this position water may be filled inside and air removed from inside the internal chamber 21 through a channel 37 in the body 31 with the plug 35 preliminarily sealing the plug socket 36 at the axially internal side of the blocking chamber 32. In other embodiments water filling may be effected solely through the pressure applying channel 353 of the plug or through both channels 37 and 353.

FIG. 4c illustrates the pressure applying phase. As shown the axial actuator has pushed the supporting frame 357, the rail 356 and the plug 35 into the plug socket 36 towards the internal chamber 21 of the vessel 2, so that the plug sealing means 351 adhere to the internal surface of the chamber 21. The actuator 346 in turn displaced the blocking gate 34 back inside the blocking chamber 32. In this position the axially external face 341 of the blocking gate 34 abuts the axially external face 321 of the blocking chamber 32, while the axially internal face 342 of the blocking gate 34 abuts the axially external face 352 of the plug 35. Water under high pressure is applied to the internal chamber 21 through the channel 353 in the plug 35. The axial reaction of the pressure acting on the plug 35 inside the chamber 21 is transferred by the plug 35 to the blocking gate 34 that it acts upon and further by the blocking gate 34 to the body 31. Finally the extending forces are transferred by the body 31 to the already prestressed tie-rods 4 (cf. FIG. 2).

In yet another embodiment of the present invention the high pressure assembly may comprise a number of vessels 2 disposed in parallel with each other and closed at their axial ends with common head assemblies 3.

The above embodiments of the present invention are merely exemplary. The figures are not necessarily to scale, and for clarity some features may be exaggerated, minimized or omitted. These and other factors, however, should not be considered as limiting the spirit of the invention, the intended scope of protection of which is indicated in appended claims.

### LIST OF THE REFERENCE NUMERALS

1. high pressure assembly (1a, 1b)

2. high pressure vessel
21. internal chamber

3. head assembly
31. body
32. blocking chamber
   321. axially external face
33. loading outlet
34. blocking gate
   341. axially external face
   342. axially internal face
   343. loading channel
   346. actuator
35. plug
   351. sealing means
   352. axially external face
   353. pressure applying channel
   356. rail
   357. supporting frame
36. plug socket
37. channel

4. tie-rod
41. external thread
42. nut
   421. resisting surface
43. resisting surface

5. product

6. tie member (6a, 6b)

1. A high pressure isostatic pressing assembly (1a, 1b) for food processing, comprising
at least one high pressure vessel (2) having an internal chamber (21) closed at axial ends of the vessel (2) with two head assemblies (3), each comprising a body (31) adjoining a respective end of the vessel (2), wherein
at least one head assembly (3) further comprises
a blocking chamber (32) located within the body (31) transversely relative to a longitudinal axis (A) of the vessel (2),
a loading outlet (33), substantially aligned with the longitudinal axis (A) of the vessel (2), joining an axially external side of the body (31) with said blocking chamber (32), and having cross-sectional area substantially corresponding to a cross-sectional area of the vessel (2), and
a plug (35) disposed displaceably within the blocking chamber (32) and provided with a sealing means (351) apt to enter and sealingly close the internal chamber (21) of the vessel (2) during a pressure applying phase of the vessel (2), the assembly further comprising
at least two longitudinal tie-rods (4) juxtaposed around an external surface of the vessel (2) at a radially external side of the blocking chamber (32),
wherein an end of each tie rod (4) passes through a tie member (6) coupled with the vessel and is coupled with a resisting surface (421, 43) transferring axial load on said tie member (6) at an axially external side of said end of each tie rod (4), and
wherein said resisting surface (421, 43) axially preloads said end of each tie-rod (4), the body (31) and the vessel (2) with a preload force, and the preload force is adjusted at least to a value ensuring that no separation between the body (31) and the vessel (2) occurs during a loading phase and a closing phase of the vessel (2), as well as during a pressure applying phase of the vessel (2) so that the vessel (2) is axially compressed for all pressures acting inside the vessel (2) by the head assemblies (3) coupled with the tie-rods (4).

2. The high pressure assembly according to claim 1, wherein the bodies (31) of the two head assemblies (3) of the high pressure isostatic pressing assembly (1a) are coupled with each other by said at least two longitudinal tie-rods (4).

3. The high pressure assembly according to claim 2, wherein a combined preload force (Tₚ) of said at least two tie-rods (4) is adjusted at least to a value of an axial force (Fᵥ) generated in the vessel (2) during the pressure applying phase multiplied by an axial stiffness (Cᵥ) of the vessel (2) relative to an axial stiffness (Cₜ) of said at least two tie-rods (4) and the axial stiffness (Cᵥ) of the vessel (2) according to a formula Tₚ≥Fᵥ·Cᵥ/(Cᵥ+Cₜ).

4. The high pressure assembly according to claim 1, wherein said tie member (6a) is the body (31) of the head assembly (3).

5. The high pressure assembly according to claim 1, wherein said tie member (6) adjoins or is coupled with the body (31) of the head assembly (3).

6. The high pressure assembly according to claim 1, wherein the body (31) of the head assembly (3) has a multipart construction and said tie member (6) is a most axially external part of said body (31) transferring axial loads on the vessel (2).

7. The high pressure assembly according to claim 1, wherein the blocking chamber (32) of said at least one head assembly (3) is provided with an axially external face (321) and the plug (35) is provided with an axially external face (352), wherein said at least one head assembly (3) further comprises a blocking gate (34) having axial width lower than an axial width of the blocking chamber (32), wherein the blocking gate is disposed slidably within said blocking chamber (32) and is provided with an axially external face (341) abutting said axially external face (321) of the blocking chamber (32) and an axially internal face (342), wherein the axially external face (352) of the plug (35) abuts the axially internal face (342) of the blocking gate (34) during the pressure applying phase and is axially displaced from the axially internal face (342) of the blocking gate (34) toward the loading outlet (33) during the loading phase.

8. The high pressure assembly according to claim 7, wherein the blocking gate (34) is provided with a loading channel (343) having cross-sectional area substantially corresponding to a cross-sectional area of the internal chamber (21) of the vessel (2), that passes between said axially external face (341) and said axially internal face (342) of said blocking gate substantially in parallel with the axis (A) of the vessel (2), and during the loading phase is substantially aligned with the loading outlet (33).

9. The high pressure assembly according to claim 7, wherein the plug (35) is supported on the blocking gate (34).

10. The high pressure assembly according to claim 1, wherein at least one head assembly (3) further comprises a plug socket (36) joining the blocking chamber (32) with the internal chamber (21) of the vessel (2) and the plug (35) is disposed displaceably also within the plug said plug socket (36).

11. The high pressure assembly according to claim 1, wherein displacements of the plug (35) within the blocking chamber (32) are determined with respect to the body (31) of the head assembly (3).

12. The high pressure assembly according to claim 1, wherein the plug (35) is provided with a pressure applying channel (353).

13. The high pressure assembly according to claim 1, wherein the resisting surfaces (421, 43) are pressed by at least one nut (42).

14. The high pressure assembly according to claim 13, wherein the at least one nut (42) is screwed on an external thread (41) of the end of each tie rod (4).

15. The high pressure assembly according to claim 1, wherein said resisting surfaces (421, 43) are pressed by a multi-bolt tensioning system.

16. The high pressure assembly according to claim 1, wherein the assembly comprises a number of vessels (2) disposed in parallel with each other and closed at respective axial ends thereof with a common head assembly (3).

17. The high pressure assembly according to claim 1, wherein the at least two longitudinal tie-rods (4) are juxtaposed symmetrically around the external surface of the vessel (2) at the radially external side of the blocking chamber (32).
